(19) United States
(12) Patent Application Publication
(10) Pub. No.: US 2025/0310252 A1
(43) Pub. Date: Oct. 2, 2025

(54) RADIO ROUTING

(71) Applicant: Nordic Semiconductor ASA, Trondheim (NO)

(72) Inventor: Antti Tapani KAUPPILA, Oulu (FI)

(73) Assignee: Nordic Semiconductor ASA, Trondheim (NO)

(21) Appl. No.: 18/864,483

(22) PCT Filed: May 10, 2023
(86) PCT No.: PCT/EP2023/062484

§ 371 Date: Nov. 8, 2024

(30) Foreign Application Priority Data
May 13, 2022 (GB) 2207030.4

(51) Int. Cl. H04L 45/74; H04L 45/48; H04W 84/18

(52) U.S. Cl. CPC H04L 45/74; H04L 45/48; H04W 84/18

(57) ABSTRACT

A radio communication system comprises radio devices configured as a radio mesh network. A source device transmits a message through the mesh network for receipt by a destination device. The message encodes an identifier of the source device. Each of one or more intermediate devices, located sequentially along a path from the source to the destination, receives the message, encodes a respective identifier within the message, and transmits the message along the path towards the destination. The destination receives the message and decodes the identifiers of the source and intermediate devices. It transmits a second message, for receipt by the source, that encodes the identifiers of the source and the intermediate devices. Each of the intermediate devices receives the second message, decodes an identifier of a next device along the communication path towards the source device, and uses the identifier to transmit the second message to the next device.

### BACKGROUND OF THE INVENTION

This invention relates to routing in radio mesh networks.

Wireless mesh networks allow radio devices, arranged as nodes of the network, to communicate with each in a decentralised ad hoc manner. Messages can be relayed between device over multiple hops, allowing two devices to communicate even when they are located beyond radio range of each other. Mesh networks allow systems to be deployed flexibly and scalably, with less need for fixed infrastructure such as cabling compared with traditional planned networks. They are well suited for efficiently deploying networks of smart devices in a residential or industrial building, such as wireless light switches and wireless luminaires, or other types of wireless sensors and appliances. Radio devices may be fixed or mobile. They may be powered by an external electrical supply or by an internal source such as a battery and/or photovoltaic cells.

One example of a protocol for radio mesh networking is ETSI's DECT-2020 New Radio (NR) standard, which operates in a license-exempt 1.9 GHz frequency band.

Because of the decentralised nature of mesh networks, routing messages efficiently is challenging. It may, in some situations, be feasible for nodes to determine and maintain knowledge of how to route message towards one particular special node, such as the sink node (which is an Internet gateway) for the network in DECT-2020 NR, such the network collectively maintains a distributed routing tree. This routing tree may enable efficient routing of messages to that special node, but it does not enable it for other destination radio devices within the network. Because of the processing and bandwidth constraints of typical mesh networks, it is not in general practicable for every node to acquire and maintain a full routing table for the whole network.

Therefore, a simplistic approach to transmitting a message from a source radio device to an arbitrary destination radio device in the network is for every intermediate device that receives the message to transmit a copy to every device in range, or at least to every device which the intermediate device has previously been associated (i.e. paired). However, such flooding-based routing can be very wasteful of radio bandwidth and of processing and electrical power in the radio devices. The efficiency may be somewhat improved using selective and/or hop-limited flooding techniques, but these are still inherently wasteful.

Embodiments of the present invention seek to provide a more efficient approach to routing data in a radio mesh network.

### SUMMARY OF THE INVENTION

From a first aspect, the invention provides a radio communication system comprising a plurality of radio devices configured as a radio mesh network, wherein:
a source radio device of the plurality of radio devices is configured to transmit a first message by radio through the radio mesh network for receipt by a destination radio device of the plurality of radio devices, wherein the first message encodes an identifier of the source radio device;
each of one or more intermediate radio devices of the plurality of radio devices, located sequentially along a communication path through the radio mesh network from the source radio device to the destination radio device, is configured to receive the first message, encode an identifier of the respective intermediate radio device within the first message, and transmit the first message by radio through the radio mesh network along the communication path in a direction towards the destination radio device;
the destination radio device is configured to receive the first message and decode the respective identifiers of the source radio device and of each of the one or more intermediate radio devices from the first message;
the destination radio device is configured to transmit a second message by radio through the radio mesh network for receipt by the source radio device, wherein the second message encodes the respective identifiers of the source radio device and of each of the one or more intermediate radio devices; and
each of the one or more intermediate radio devices is configured to receive the second message, decode from the second message a respective identifier of a respective next radio device along the communication path in a direction towards the source radio device, the respective next radio device being one of the one or more intermediate radio devices or the source radio device, and use the respective identifier to transmit the second message by radio to the respective next radio device.

From a second aspect, the invention provides a radio device, for use in a communication system that comprises a plurality of radio devices configured as a radio mesh network, wherein the radio device is configured to act as a destination radio device by:
receiving a first message, transmitted through the radio mesh network from a source radio device for receipt by the radio device;
decoding respective identifiers of the source radio device and of each of one or more intermediate radio devices of the plurality of radio devices from the first message; and
transmitting a second message by radio through the radio mesh network for receipt by the source radio device, wherein the second message encodes the respective identifiers of the source radio device and of each of the one or more intermediate radio devices.

From a third aspect, the invention provides a radio device, for use in a communication system that comprises a plurality of radio devices configured as a radio mesh network, wherein the radio device is configured to act as an intermediate radio device by:
receiving a first message, for receipt by a destination radio device of the plurality of radio devices, travelling along a communication path through the radio mesh network from a source radio device of the plurality of radio devices to the destination radio device;
encoding an identifier of the device radio within the first message;
transmitting the first message by radio through the radio mesh network along the communication path in a direction towards the destination radio device;
receiving a second message, transmitted by the destination radio device for receipt by the source radio device, wherein the second message encodes the respective identifiers of the source radio device and of each of one or more intermediate radio devices of the plurality of radio devices;
decoding from the second message an identifier of a next radio device along the communication path in a direction towards the source radio device, the next radio device being one of the one or more intermediate radio devices or the source radio device; and
using the identifier to transmit the second message by radio to the next radio device.

From a fourth aspect, the invention provides a method of routing messages in a radio mesh network comprising a plurality of radio devices, the method comprising:
a source radio device of the plurality of radio devices transmitting a first message by radio through the radio mesh network for receipt by a destination radio device of the plurality of radio devices, wherein the first message encodes an identifier of the source radio device;
each of one or more intermediate radio devices of the plurality of radio devices, located sequentially along a communication path through the radio mesh network from the source radio device to the destination radio device, receiving the first message, encoding an identifier of the respective intermediate radio device within the first message, and transmitting the first message by radio through the radio mesh network along the communication path in a direction towards the destination radio device;
the destination radio device receiving the first message and decoding the respective identifiers of the source radio device and of each of the one or more intermediate radio devices from the first message;
the destination radio device transmitting a second message by radio through the radio mesh network for receipt by the source radio device, wherein the second message encodes the respective identifiers of the source radio device and of each of the one or more intermediate radio devices; and
each of the one or more intermediate radio devices receiving the second message, decoding from the second message a respective identifier of a respective next radio device along the communication path in a direction towards the source radio device, the respective next radio device being one of the one or more intermediate radio devices or the source radio device, and using the respective identifier to transmit the second message by radio to the respective next radio device.

Thus it will be seen that, in accordance with embodiments of the invention, the second message encodes routing information identifying the communication path that the first message followed through the mesh network to get from the source to the destination, thereby enabling the second message to be routed along the same communication path but in the opposite direction—i.e. back from the destination to the source. This can enable such second messages to be routed efficiently even in networks whose nodes do not hold full routing information. This may improve the radio bandwidth efficiency of the system and/or reduce electrical power consumption in the radio devices.

The radio communication system may be configured to route the first message according to a tree-based routing protocol. This may comprise unicast routing to a single recipient at each hop or may comprise flooding-based routing.

In a first set of embodiments, the first message is transmitted only to the one or more intermediate radio devices along the communication path and to the destination radio device. Each radio device that receives the first message transmits it to at most one further radio device—e.g. as a unicast transmission to a single recipient. Respective instances of the first message may be addressed to respective successive radio devices as the first message is communicated along the communication path (i.e. at each hop, a respective copy of the first message may encode, as a recipient address for that copy, the identifier or other form of address of the respective next radio device on the path). The first message may be routed according to a tree-based routing protocol in which the destination radio device is at a root of the tree. The destination radio device may have a unique status within the mesh network. It may, for instance, be a gateway to a further network such as to the Internet. It may be the only gateway in the mesh network. It may be configured to operate as a DECT-2020 NR sink node. In this first set of embodiments, the present methods allow the routing of the second message to be as efficient as the routing of the first message, without having to rely on flooding-based routing, even when the network does not store a routing tree having the source radio device as its root, or other full routing information for reaching the source radio device from anywhere in the mesh network.

In a second set of embodiments, the first message is routed by flooding. This may comprise comprehensive flooding of the message by each node that receives the message to every node that is associated (i.e. paired) with the respective receiving node, or it may comprise selective flooding and/or hop-limited flooding. It may comprise selective flooding using tree-based routing, wherein neither the source radio device nor the destination radio device is at a root of the tree. The first message may thus be transmitted (e.g. by unicast or multicast transmission) to at least one radio device that is not the destination radio device and that is not along a communication path from the source radio device to the destination radio device. At least one device of the source radio device and the one or more intermediate radio devices may thus transmit respective copies of the first message (e.g. as respective unicast transmissions) directly to each of a plurality of radio devices. In this second set of embodiments, the routing of the second message can be more efficient than the routing of the first message, since the first message will typically have traversed many unsuccessful paths that never reached the destination radio device, with only a smaller number of paths (e.g. only one path) successfully delivering the message to the destination radio device, whereas the second message can be sent directly along one of these successful paths, e.g. by unicast transmission to a single recipient at each hop rather than by flooding.

The destination radio device may receive only one instance of the first message (e.g. if the radio devices are associated with each in a way that prevents loops, such as according to a tree-based hierarchy), or it may receive a plurality of copies of the first message encoding different sets of intermediate radio device identifiers. The destination radio device may be configured so that, if it receives a plurality of copies, it identifies a copy meeting a selection criterion and encodes, in the second message, the identifiers of the one or more intermediate radio devices decoded from the identified copy. The selection criterion may identify a copy that traversed a smallest number of hops, or a copy that was received first by the destination radio device. This may allow the routing of the second message to follow a path that is likely to be optimal for the return journey too (e.g. having fewest hops and/or involving radio devices that are least heavily loaded). In this second set of embodiments, the source and destination radio devices may be any radio devices of mesh network—i.e. without either necessarily having any special status such as being a gateway to another network.

The destination radio device and the one or more intermediate radio devices may each transmit the second message to only one respective radio device. This can provide for particularly efficient routing of the second message.

The destination radio device may store data associating the source radio device identifier with the identifiers of the one or more intermediate radio devices. It may store this data in a memory of the destination radio device. The data may be stored as an entry in a database. The database may associate (e.g. map) source radio devices to respective sets of one or more intermediate radio devices. The destination radio device may be configured to store respective identifiers of a plurality of different source radio devices, each identifier being associated with a respective set of identifiers of one or more intermediate radio devices. The memory may have space for a maximum number of data entries, and the destination radio device may be configured so that, when the database has the maximum number of entries, an oldest entry is replaced when adding a new entry. The destination radio device may use the stored data when generating or transmitting the second message. It may use the source radio device identifier to retrieve the identifiers of the one or more intermediate radio devices from a database.

All, or all but one (e.g. a gateway device), of the plurality of radio devices may be configured to act as intermediate radio devices when receiving a message for which it is not the destination. A gateway radio device may be configured to act as a destination radio device but not necessarily as an intermediate radio device. All of the plurality of radio devices may also be configured to act as source radio devices for certain messages (e.g. for messages originating from the radio device but for which the radio device does not know identifiers of intermediate nodes along a communication path to the destination of the message). In some embodiments (e.g. at least in some of the second set of embodiments disclosed above), all of the plurality of radio devices may be configured to act as destination radio devices for certain messages (e.g. messages destined for the radio device that encode identifiers of the source and intermediate radio devices along a communication path from the source radio device). In particular, all the radio devices may be configured to store data associating one or more source radio device identifiers with sets of identifiers of one or more intermediate radio devices along respective communication paths from the source radio devices.

The one or more intermediate radio devices may be configured to encode their respective identifiers as an ordered list within the first message. The order of the identifiers in the list may be represented by the positions of the identifiers within the first message (e.g. corresponding to different temporal position during transmission of the first message), or may be represented in any other way (e.g. by sequence information encoded separately from the identifiers). The order may correspond to their sequence (i.e. order) along the communication path. Each intermediate radio device that receives the first message (i.e. that receives a copy of the first message) may be configured, when transmitting the first message, to append its respective identifier to an end of an ordered list that was present in the received first message (which may contain zero, one or more identifiers when the radio device received it).

The destination radio device may encode the respective identifiers of the one or more intermediate radio devices as an ordered list within the second message. This may correspond to an ordered list of the identifiers encoded in the first message as received by the destination radio device. The ordering may be the same or may be reversed. This preservation of ordering information is not essential, but it may improve the efficiency with which each intermediate radio device decodes, from the second message, the respective identifier of the respective next radio device along the communication path, e.g. by avoiding a need for the device to search through the identifiers to identify a match with a radio device to which it has been associated.

The destination radio device may store data associating the source radio device identifier with the identifiers of the one or more intermediate radio devices as an ordered list, corresponding to an ordered list of the identifiers encoded in the first message as received by the destination radio device.

Each radio device may be configured to enter a low-power state when the device is not transmitting radio signals. Approaches disclosed herein can help support power saving in such systems by enabling more radio devices to be in the low-power state by requiring fewer radio devices to transmit copies of the second message than would typically be the case using flooding-based routing.

The first and second messages may be respective radio packets. They may each comprise a header. The identifiers of the intermediate radio device may be encoded in one or more fields of the header. The first and second messages may encode (e.g. in respective header fields) any one or more of: an identifier of the source radio device; an identifier of destination radio device; an identifier of a radio device that is transmitting the message (i.e. that is transmitting this copy of the message); and an identifier of a recipient radio device for the message (i.e. for this copy of the message).

The first and second messages may each encode a direction indicator, for indicating a direction of transmission of the message through the network. The direction may be determined with reference to a routing tree or to a radio device of special status, such as a gateway. Each of the one or more intermediate radio devices may be configured, when receiving a message, to decode the direction indicator from the message and determine whether to encode its identifier within the message and/or whether to decode an identifier of a next radio device from the received message in dependence on the direction indicator. However, the provision of an explicit direction indicator in the messages is not essential in all embodiments.

It will be appreciated that each message may be modified for the purpose of routing the message through the mesh network when different copies of the message are transmitted between respective pairs of radio devices, e.g. with different identifiers or addresses being included in the message header, or a hop counter being incremented. References herein to the first message and the second message encompass such copies of and modifications to the original messages.

The destination radio device may transmit the second message in response to receiving the first message. The first message may be a request message and the second message may be a response message, transmitted in response to the request message. However, this is not essential in all embodiments, and in some situations the second message may be sent independently of the receiving of the first message (but after the destination radio device received the first message).

The plurality of radio devices may all be configured to implement a common routing protocol. More generally, they may all be configured to transmit and receive messages according to a common radio communication protocol, which may be a proprietary or standardised protocol. This could be any protocol that supports mesh networking. However, in some embodiments, all the radio devices implement at least the MAC layer specification, or all parts, of a current or future version of the DECT-2020 New Radio (NR) standard. In some embodiments, all the radio devices implement a current or future version of the Bluetooth Low Energy specification.

Each radio device may comprise radio transceiver circuitry for transmitting and receiving messages. Each may comprise or may be an integrated-circuit radio transceiver—e.g., a silicon chip. Each may comprise, or be connectable to, one or more off-chip components, such as a power supply, antenna, crystal, discrete capacitors, discrete resistors, etc. Each may comprise one or more processors, DSPs, logic gates, amplifiers, filters, digital components, analog components, non-volatile memories (e.g., for storing software instructions), volatile memories, memory buses, peripherals, inputs, outputs, and any other relevant electronic components or features. Each radio device may comprise a memory storing software instructions for execution by a processing system of the radio device. The software instructions may instruct the device for performing any of the steps or operations disclosed herein. Each device may comprise a DSP and/or a general purpose processor, such an Arm™ Cortex-M™ processor. Any of the processing steps disclosed herein may be performed wholly in software, or wholly by hardwired circuitry (e.g., using digital logic gates), or by a combination of software and hardware.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of a radio mesh network of radio devices embodying the invention;

FIG. 2 is a schematic diagram of an exemplary radio device of the radio mesh network;

FIG. 3 is a routing tree for the radio mesh network;

FIG. 4 is the routing tree of FIG. 3 highlighted to show an outbound path through the radio mesh network;

FIG. 5 is the routing tree of FIG. 3 highlighted to show a return path through the radio mesh network when using selective flooding;

FIG. 6 is schematic diagram of the structure of an exemplary data packet for communicating a message through the radio mesh network using methods embodying the invention;

FIG. 7 is flow chart of a message exchange between a node of the network and a remote server according to a method embodying the invention;

FIG. 8 is the routing tree of FIG. 3 highlighted to show a return path through the radio mesh network when using a method embodying the invention;

FIG. 9 is the routing tree of FIG. 3 highlighted to show a request transmission path through the radio mesh network between a pair of nodes; and

FIG. 10 is the routing tree of FIG. 3 highlighted to show a return transmission path through the radio mesh network between a pair of nodes when using a method embodying the invention; and

FIG. 11 is flow chart of a message exchange between two nodes of the network according to a method embodying the invention.

### DETAILED DESCRIPTION

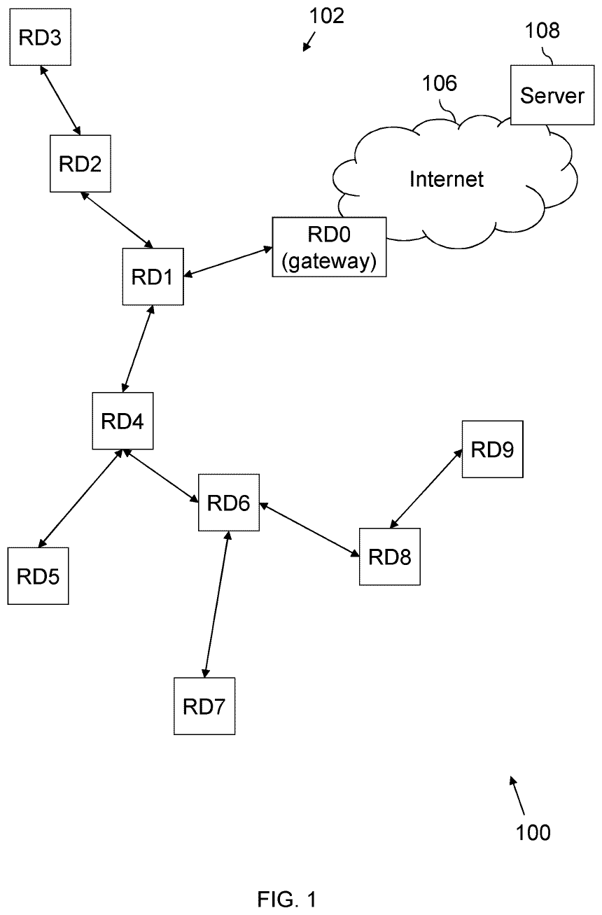

FIG. 1 shows a system 100 comprising a mesh network 102 of ten radio devices, RD0-RD9, configured for short-range or medium-range radio communication as a single mesh network. Each radio device (RD) is associated with one or more other RD, with which it is in radio communication range, by having performed a predetermined association protocol. These pairwise device associations are represented by double-ended arrows in FIG. 1. The associations could be directionless, but in some embodiments that are directional, e.g. according to a child-parent relationship.

The RDs could support any standardised or proprietary radio communication protocol that supports radio mesh networking. However, in some embodiments, the RDs are configured to perform an association as defined in a current or future version of the DECT-2020 New Radio (NR) standard.

One of the nodes, RD0 104, is a special gateway node. It has a connection to the Internet 106 and acts as a bridge between the mesh network 102 and the Internet 106. Some of the other RDs—in this example, RD3, RD5, RD7, RD9—are leaf nodes of the mesh network, being associated with only one other RD. The remaining RDs—in this example, RD1, RD2, RD4, RD6, RD8—are branch nodes, being associated with at least two other RDs. In the terminology of DECT-2020, the leaf nodes are “portable terminals” (PT) and the branch nodes are “fixed terminals” (FT); however, these are legacy terms as any of the RDs of the network 100 may be fixed or portable devices.

In some embodiments, the RDs may be smart devices in a residential or industrial building—e.g. with some or all of them being either a wireless light switch or a wireless luminaire, or any other sensor or control devices. The RDs may be Internet-of-Things (IoT) devices, and may be accessible from the Internet 106 through the gateway RD0. In this example, some or all of the RDs can communicate with a server 108, accessed through the Internet 106. This may be remote from the mesh network 102, e.g. being in a different building, town, state or country from the mesh network 102.

Although FIG. 1 shows the radio mesh network 102 having ten RDs, it will be appreciated that it could have any number of RDs, which may be larger or smaller than ten. The number of associated RDs may also change dynamically over time for the same network 102.

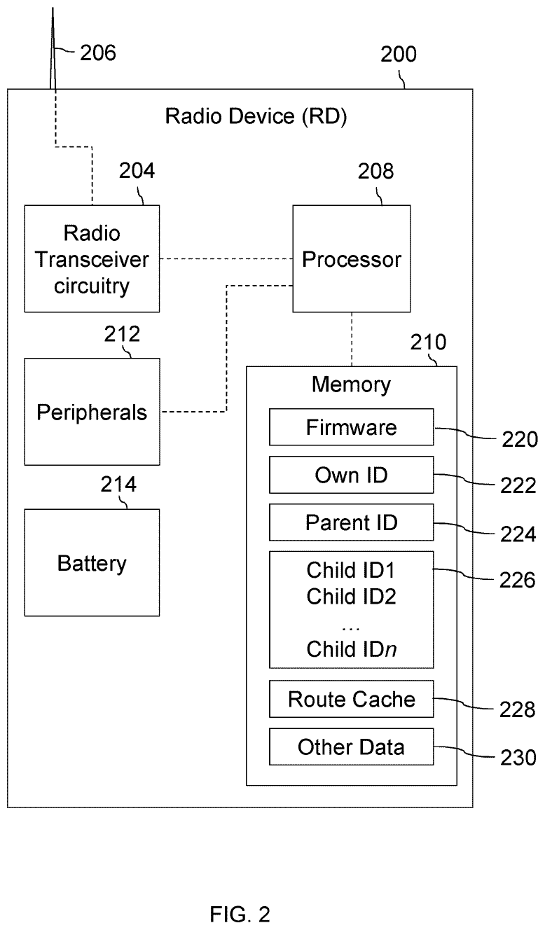

FIG. 2 schematically shows a representative radio device 200 that may be used in the mesh network 102. Some or all of the ten RDs shown in FIG. 1 may be devices similar to the RD 200 shown in FIG. 2, although this is not essential.

The RD 200 comprises radio transceiver circuitry 204 for performing full-duplex or half-duplex digital radio communication according to a standardised or proprietary radio protocol—e.g. DECT-2020. This circuitry 204 is coupled to a radio antenna 206. The RD 200 also contains a processor 208 which is coupled to the radio transceiver circuitry 204 as well as to a memory 210 and a set of peripherals 212. The radio transceiver circuitry 204, processor 208 and memory 210 may all be integrated on a single System on Chip (SoC) although this is not essential. Some of the peripherals 212 may also be at least partly integrated with the processor 208. The peripherals 212 may include communication ports, analog circuitry, digital circuitry, etc. They may include interfaces to physical features of the RD 200 such as a switch (e.g. a light switch), a lamp, an LED, etc. The RD 200 could be an appliance such as a washing machine, or a manufacturing robot in a factory, or it could be a module for incorporation within such an appliance or a larger device. The RD 200 may be powered externally, but in the example shown in FIG. 2 it is powered by an internal battery 214.

The memory 210 may comprise volatile (e.g. SRAM) and/or non-volatile (e.g. flash) memory regions. The memory 210 has space 220 for storing firmware 220 comprising software instructions for execution by the processor 208. It also includes an “Own ID” space 222 for storing an identifier (ID) of the RD 200 itself, as well as a “Parent ID” space 224 for storing an ID of a parent RD, and “Child ID” spaces 226 for storing up to a maximum number, n, of IDs of child RDs. This RD 200 also has a “Route Cache” space 228 for storing route cache data when the RD 200 is configured to act as a gateway device as described below. RDs that are not acting as a gateway may simply not use this portion of the memory 210 or they may omit it for reasons of economy. Finally, the memory 210 has space 230 for storing any other data required to operate the device 200. The spaces 222-230 for data may be reserved (e.g. as registers with fixed addresses) or they may be allocated dynamically as required (e.g. by the firmware 220 or a hardware memory manager). They may be volatile or non-volatile.

The firmware 220 can be executed by the processor 208 in order to control the hardware of the RD 200 for performing any of the radio communication methods and operations disclosed herein.

Each RD in the mesh network 102 stores a respective device ID (e.g. a serial number) which is unique to the RD within the mesh network 102. It may be written to the Own ID space 222 of the RD 200 during a manufacturing or commissioning step, or could be generated by the RD during an initialisation (e.g. boot) process. Each RD also stores an ID of a parent RD and optionally stores IDs of one or more child RDs, for efficient routing of messages within the mesh network 102. These could be assigned manually by a human installer, or they could be determined automatically by the RDs themselves e.g. using a network association or device-discovery protocol implemented by the RDs. The allocation of child-parent relationships may be based on factors such as received signal strength indicators (RSSIs) between pairs of RDs, or in any other appropriate way.

The values of the respective parent ID and any child IDs stored by each RDs define a tree of device associations for the mesh network 102, with the parent IDs identifying RDs closer to a root of the tree, and child IDs identifying RDs closer to the leaves of the tree. The RDs can use this tree for efficiently routing messages through the network 102.

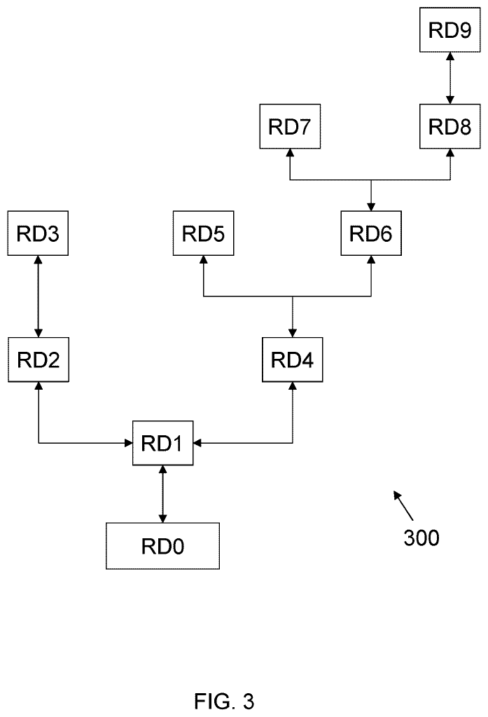

FIG. 3 shows such an exemplary routing tree 300 for the mesh network 102, based on the device associations represented in FIG. 1, in which the gateway, RD0, is at the root of the tree, and the other RDs correspond either to branch nodes (RD1, RD2, RD4, RD6, RD8) or leaf nodes (RD3, RD5, RD7, RD9) of the routing tree 300. The branch RDs can act as routers, or intermediate nodes, for relaying messages between other nodes. Messages for receipt by destinations over the Internet 106, such as the server 108, are received by the gateway RD0 which acts as a sink node for such outbound (uplink) messages.

Unlike Internet routers, the RDs are low-power devices. It is desirable to minimise the quantity and size of radio transmissions each RD has to make in order to prolong battery life and also to make efficient use of limited radio bandwidth. The RDs may also have limited memory storage capacity. Accordingly, each intermediate RD does not store a full routing table representing all of the mesh network 102, since it would be impracticable to establish and maintain such tables.

Instead, the system 100 can route at least some messages by flooding, in which each RD that receives a message transmits the message, by unicast, to its parent RD and to each child RD with which it is associated (i.e. whose IDs it has stored in its memory 210). Efficiency may be improved somewhat by selective flooding, in which an intermediate RD only relays a message on to other router RDs (i.e. not to any leaf RDs), unless the RD has a direct association with the destination RD for the message, in which case it transmits it to the destination RD. Further efficiency gains may be realised by hop-limited flooding, in which the source RD includes a hop limit (e.g. two hops) to a message, and each intermediate RD that relays the message increments a hop count encoded in the message before it transmits it, or discards a received message if the hop limit has been reached and the RD is not the destination RD for the message. The source RD may progressively increase the hop limit until it receives an acknowledgement of receipt from the destination RD.

Even when the system 100 implements hop limits and selective flooding, this is still a quite inefficient way to route messages. The system 100 therefore also supports single-recipient unicast radio transmissions, in which each RD along a communication path passes on a message by radio transmission to at most one RD with which it is associated. This is much more power and bandwidth efficient, but requires each RD to know how to select the next RD along the path.

For messages destined for the gateway RD0 (e.g. having an ultimate destination of the remote server 108), a single-recipient unicast approach can be implemented straightforwardly. Each intermediate RD (i.e. each RD that isn't the gateway RD0) that receives a message transmits the message to its parent RD and to no other RD. However, this single-recipient approach cannot be applied to routing messages transmitted from the gateway RD0 for some destination RD within the network 102. More generally, it cannot be used to route messages between any arbitrary pair of RDs in the network 102.

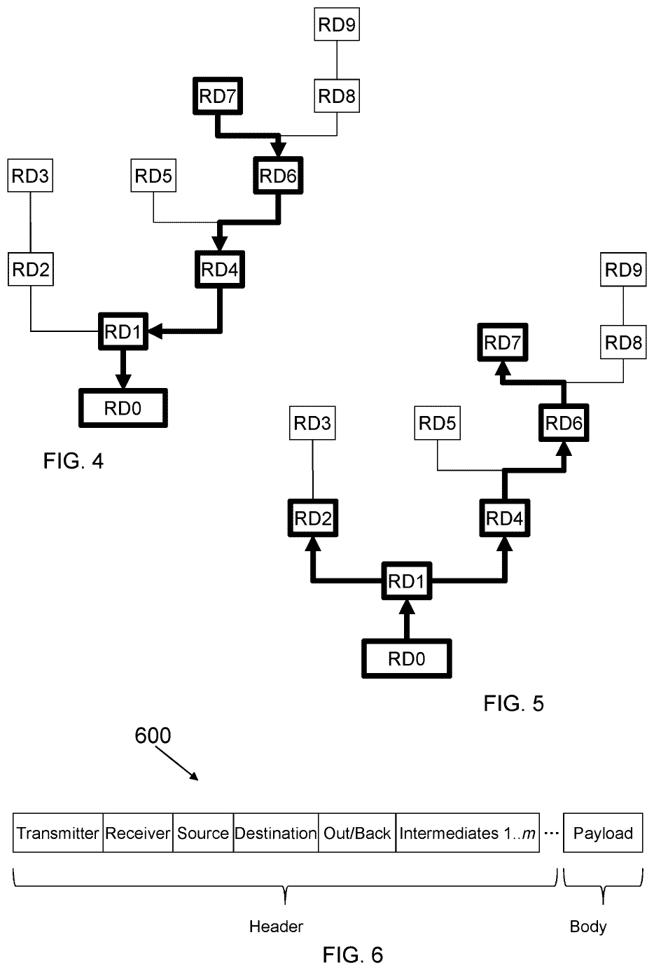

FIGS. 4 and 5 illustrate a shortcoming with such approaches, e.g. when implemented in accordance with Release 1 of Parts 4 & 5 of the DECT-2020 New Radio (NR) standard, dated December 2021.

FIG. 4 shows how a message that is transmitted by source radio device RD7 for a destination radio device of the gateway RD0 can be efficiently routed by each intermediate RD that receives the message—namely RD6, RD4 and R1—along a communication path from RD7 to RD0 forwarding the message by unicast radio transmission to its parent RD until the message reaches the gateway RD0. The message could have an ultimate destination that is the gateway RD0 or it could be passed by the gateway RD0 towards an ultimate destination (e.g. indicated by a destination IP address contained within the message) that is located over the Internet 106, such as the server 108. In either case, the message may be an uplink request message to which a downlink response message will subsequently be issued by the gateway RD0 through the mesh network 102, for receipt by the source radio device RD7.

FIG. 5 illustrates this response message being transmitted using selective flooding. The gateway RD0 transmits the second message to its only child, RD1. This node RD1 transmits the message to both its children, RD2 & RD4. The node RD2 determines that its only child is a leaf RD that is not the destination RD encoded in the response message, so it drops the message. RD4 determines that, of its children, RD5 is a leaf RD that is not the destination, but RD6 is a router node, so it transmits the message to RD6. The node RD6 determines that the destination, RD7, is one of its children, so transmits the message only to the child device RD7. In this example, there is only one wasted transmission, from RD1 to RD2, but it will be appreciated that for larger and more complex networks there may be many transmissions of copies of the message to radio devices that are not on a route to the destination, leading to inefficiency.

FIG. 6 shows an exemplary data packet structure 600, for conveying at least certain types of messages through the network 102 according to novel methods disclosed herein so as to mitigate this problem. The packet has a header portion and a body portion. The body can contain a payload.

The header has a Transmitter field for carrying the ID of the latest RD to transmit the packet and a Receiver field for the ID of the next RD to receive the packet. It also has a Source field for the ID of the RD from which the message originated and a Destination field for the ID of the RD that is the final destination of the packet within the mesh network 102. If the packet is intended for an ultimate destination outside the mesh network 102, such as over the Internet 106, this field may identify the gateway RD0.

The header also contains an Out/Back direction indicator field for indicating whether the data packet is travelling in an outward or return direction (for the purposes of instructing intermediate nodes whether to collect or use routing information in the packet). Such a direction indicator could be provided by a binary flag within an Information Element (IE) bitmask, e.g. a bitmask that might be defined in a later version of the DECT-2020 New Radio standard. The use of such an indicator field may simplify the implementation; however, it is not essential in all embodiments. RDs in some embodiments may instead determine the direction of a data packet by analysing the content of the packet directly. For instance, if the gateway RD0 is known to have a particular ID (e.g. if it always has ID=0xFFFFFFFE), the RDs may determine the direction by detecting if the source or the destination of the packet is equal to this gateway ID. In such cases, there need not necessarily be a direction indicator in the headers of the packets.

The header portion also has an Intermediate field containing a fixed or variable number, m≥0, of spaces for storing the IDs of zero or more intermediate RDs, which are written into the packet as explained below. The header may of course also contain other conventional fields, such as a field indicating the length of the payload, and fields for any other control or signaling purposes. In some embodiments, devices may have short and long format IDs (e.g. as defined in DECT-2020), and the header fields may use either, depending on the circumstances.

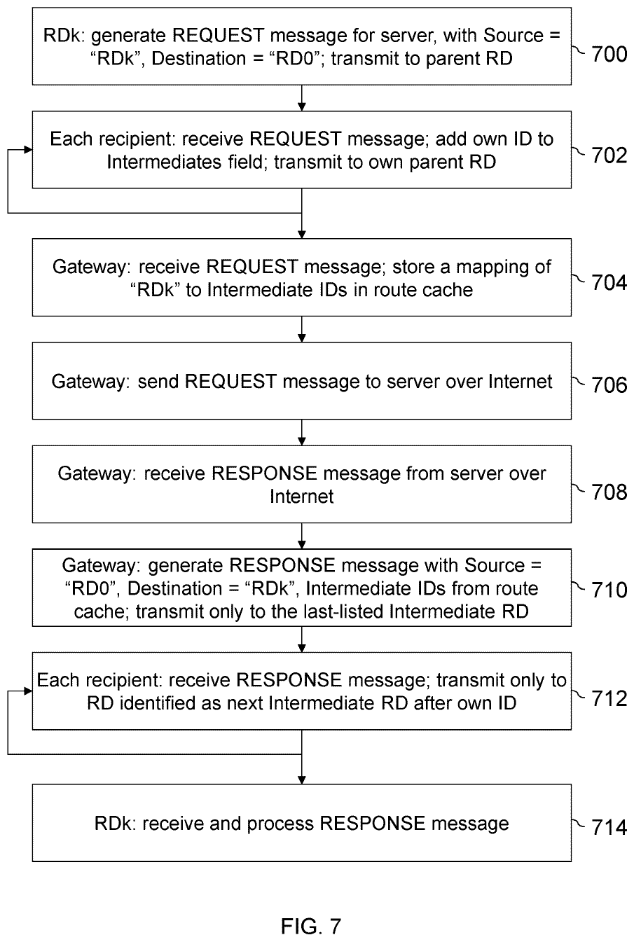

FIG. 7 outlines the method implemented by the RDs of the network 102 for providing more efficient routing of messages from the gateway RD0 to other RDs of the network 102. It illustrates the example of any one of the radio devices, RDk (for example, RD7), sending an uplink REQUEST message to the gateway RD, for onward transmission over the Internet 106 to the server 108, followed by the same radio device RDk receiving a downlink RESPONSE message from the gateway RD, containing a response from the server 108.

In a first step 700, the device RDk generates the REQUEST message, e.g. having a structure shown in FIG. 6, with the Source field containing its own ID and the Destination field indicating the ID of the gateway RD0. If the protocol requires the header to maintain a fixed length, the device RDk may reserve blank space (e.g. transmitting null values) in the Intermediates field for a number of IDs to be added into. However, in other embodiments the header may be allowed to change length in transit, and reserving space in advance may not be necessary. In embodiments that use an explicit direction indicator field, the device RDk sets the Out/Back field to an “out” value to indicate transmission in the uplink direction (i.e. towards the gateway). It puts its own ID in the Transmitter field and the ID of its parent RD in the Receive field and transmits the REQUEST message to its parent RD.

Next 702, each successive RD that receives the REQUEST message detects the “out” field (or determines the direction in any other appropriate way) and consequently adds its own ID into the Intermediates field (this may extend the message header, if spaces are not pre-allocated in the header of the incoming instance of the REQUEST message). It then transmits the (modified) REQUEST message to its own parent RD (setting the Transmitter and Receiver fields accordingly). This repeats as many times as required for the message to traverse through the routing tree to the root, being the gateway (i.e. sink) node RD0.

When 704 the gateway receives the REQUEST message, it decodes the sequence of Intermediate IDs from the header and creates a new entry in the route cache 228, based on the Source and Intermediates fields. The route cache 228 is structured as a database (e.g. a table) for storing a number of mappings, each mapping associating a respective source RD with a respective sequence of intermediate RDs. If the cache 228 already contains a mapping for the particular source RD, it may be updated to contain the latest sequence of intermediate RDs. This can allow the cache 228 to stay up-to-date with changes in the associations between RDs of the network 102 (e.g. if a RD is removed from the network 102, or if radio link between a pair of RDs is lost, or if the network is under load). The cache 228 may have space for fewer entries that there are RDs in the network 102. In this case, once the cache 228 is full, the respective oldest entry may be overwritten when each new entry is added.

Next 706 the gateway processes the REQUEST message to determine how to route it outside the mesh network 102 and sends it out over an external network such as the Internet 106 towards the server 108.

Then 708 the gateway receives a response from the server 108. This could be after a delay of milliseconds, seconds, minutes or longer. The gateway RD0 may have received and/or transmitted other messages in the meantime.

Next 710 the gateway formats this into a RESPONSE message for transmission over the radio network, e.g. having a packet structure 600 as shown in FIG. 6, with the Source field set to its own ID and the Destination field indicating the ID of RDk, i.e. the source of the earlier REQUEST message. It accesses the route cache 228 to look up the sequence of intermediate RDs associated with RDk, and writes the IDs of these intermediate RDs, in sequence, into the Intermediates field. In embodiments that use an explicit direction indicator field, the gateway sets the Out/Back field to a “back” value to indicate transmission in the downlink direction (i.e. away from the gateway). It then transmits the RESPONSE message to the RD whose ID is at the last-listed end of the Intermediates field. This will be one of the gateway device's own children.

Then 712, each successive RD that receives the RESPONSE message detects the “back” field (or determines the direction in any other appropriate way) and consequently decodes the Intermediate field to determine the next-earliest ID in the sequence after its own ID. If the header size is allowed to vary, each RD may pop this ID from the route information that is stored in the Intermediate field, thereby shortening the field by one, before transmitting the message on. It then transmits the RESPONSE message, by unicast radio transmission, to the RD having that next-earliest ID, which will be one of its own children. This repeats as many times as required for the message to traverse through the routing tree to the destination of the RESPONSE message.

After the final hop 714, the node RDk receives the RESPONSE message and can process it as appropriate based on the content of its payload.

In this way, the RESPONSE message follows exactly the same communication path through the network 102 as the REQUEST message did, but in the opposite (downlink) direction, without the RESPONSE message being transmitted to any RD that is not on the path.

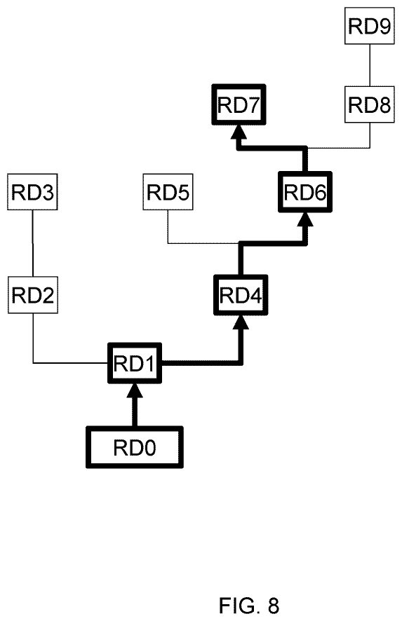

FIG. 8 illustrates the transmission of a downlink response message if this protocol is applied to the uplink message of FIG. 4. The message passes along a return path from RD0 to RD7 that is the reverse of the uplink path followed by the first message. In contrast to the flooding example shown in FIG. 5, the message is not transmitted to RD2 or any other unnecessary RD, resulting in greater efficiency, especially when this approach is applied to large networks (e.g. containing hundreds of RDs).

Although FIG. 7 illustrates a downlink message being sent in direct response to an earlier uplink message, this need not necessarily always be the case, and the gateway RD0 could also use the cache 228 for sending an unprompted message to a node such as RDk. However, this may be less feasible in practice if the memory capacity of the cache 228 is much smaller than the total number of RDs in the network.

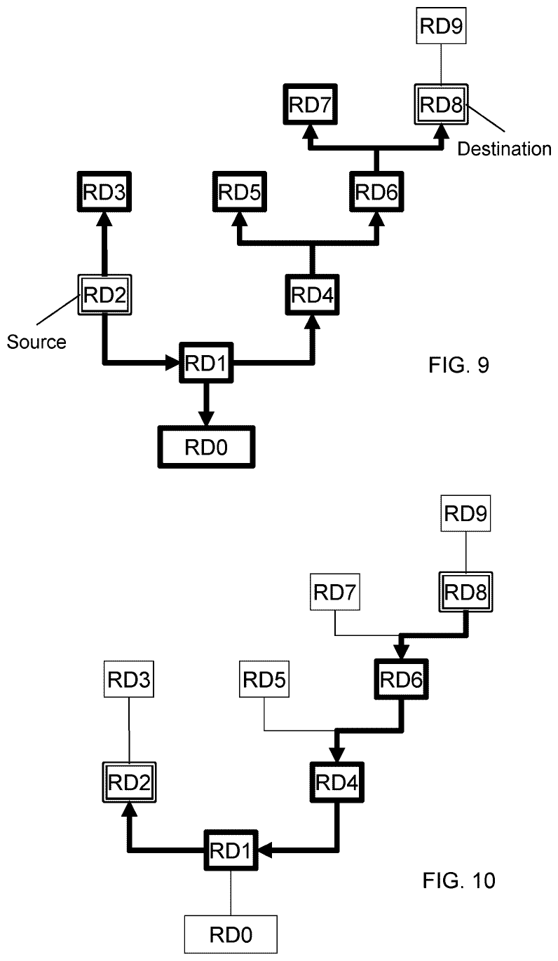

In some embodiments, RDs other than gateway RD0 may also be configured to cache routes for more efficient routing of messages between arbitrary pairs of RDs in the mesh network 102, not only involving the gateway. This is described with reference to FIGS. 9, 10 and 11.

FIG. 9 illustrates the example of a source node RD2 sending an outbound message to a destination node RD8 within the network. This is a request message, to which the node RD8 will then respond with a response message. The request message is routed by flooding, as shown in FIG. 9. If comprehensive flooding protocol is used, this will result in four RDs that are not on a direct path from RD2 to RD8 receiving copies of the message: RD3, RD0, RD5 & RD7. In a naïve approach, the same flooding protocol could be used for transmitting the response message; however, methods disclosed herein can substantially improve the efficiency of the response message, so that it follows the same direct communication path from RD2 to RD8 as the response message follows, in the return direction, as shown in FIG. 10, without any unnecessary transmissions to RDs not on this path (such as to RD7, RD5, RD0 or RD3).

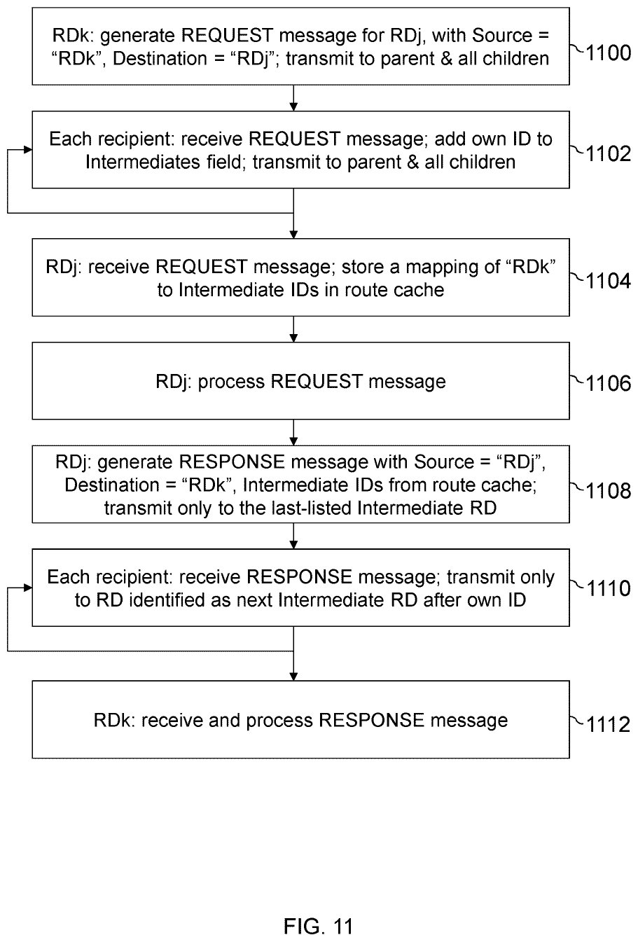

This can be achieved as shown in FIG. 11, by, in a first step 1100, the source node RDk (e.g. RD2) generating the REQUEST message for the destination node RDj (e.g. RD8) using a data packet as shown in FIG. 6, with the Source field identifying RDk and the Destination field identifying RDj. In embodiments that use an explicit direction indicator field, the node RDk sets the Out/Back field to an “out” value to indicate transmission in an outbound direction. This signals to intermediate nodes that route information should be collected into the data packet. The REQUEST message is flooded by RDk sending copies by unicast transmission to the parent RD and each child RD of the source node RDk (i.e. with the Receiver field of each copy respectively set to a different one of the parent or child RDs).

Next 1102, each successive RD that receives the REQUEST message detects the “out” field (or determines the direction in any other appropriate way) and consequently adds its own ID into the Intermediates field (this may extend the message header if spaces are not pre-allocated in the header of the incoming instance of the REQUEST message). It then floods the (modified) REQUEST message to its own parent RD and each of its child RDs (setting the Transmitter and Receiver fields accordingly). This repeats as many times as required for the message to traverse through the routing tree to the destination node RDj.

When 1104 the destination node RDj receives the REQUEST message, it decodes the sequence of Intermediate IDs from the header and creates a new entry in the route cache 228 of the destination node RDj, based on the Source and Intermediates fields. The route cache 228 is structured as already described above.

Next 1106 the destination node RDj processes the REQUEST message. This processing will depend on the nature of the message and any payload it contains.

When 1108 the destination node RDj is ready to respond, it generates a RESPONSE message, e.g. having a packet structure 600 as shown in FIG. 6, with the Source field set to its own ID and the Destination field indicating the ID of RDk, i.e. the source of the earlier REQUEST message. It queries its route cache 228 to look up the sequence of intermediate RDs associated with destination RDk, and writes the IDs of these intermediate RDs, in sequence, into the Intermediates field. It sets the Out/Back field to a “back” value to indicate transmission in a return direction. This signals to intermediate nodes that route information should not be collected but should instead be read from the data packet and used for single-recipient unicast transmission rather than flooding. It then transmits the RESPONSE message to the RD whose ID is at the last-listed end of the Intermediates field.

Then 1110, each successive RD that receives the RESPONSE message detects the “back” field and consequently decodes the Intermediate field to determine the next-earliest ID in the sequence after its own ID. It then transmits the RESPONSE message, by unicast radio transmission, to the RD having that next-earliest ID, which could be its parent or one of its own children. This repeats as many times as required for the message to traverse through the routing tree to the destination of the RESPONSE message, RDk.

After the final hop 1112, the node RDk receives the RESPONSE message and can process it as appropriate based on the content of its payload.

In some embodiments, only the gateway RD0 collects and uses a route cache 228, while in other embodiments some or all of the RDs of the network 102 may do so. They may use the route cache only for sending responses to incoming request messages, or some embodiments may also use the route cache for routing unprompted messages (e.g. request messages) where a route for the destination of the message is already stored in the cache. The RDs may optionally retire routes from the cache that are older than a predetermined maximum age, or that have been used more than a maximum number of times (which could be just once in some embodiments). This may help to avoid incorrect routing due to more recent changes to the network.

It will be appreciated by those skilled in the art that the invention has been illustrated by describing one or more specific embodiments thereof, but is not limited to these embodiments; many variations and modifications are possible, within the scope of the accompanying claims.

We claim:

1. A radio communication system comprising a plurality of radio devices configured as a radio mesh network, wherein the radio communication system comprises:
a source radio device of the plurality of radio devices;
a destination radio device of the plurality of radio devices; and
one or more intermediate radio devices of the plurality of radio devices, located sequentially along a communication path through the radio mesh network from the source radio device to the destination radio device,
wherein:
the source radio device is configured to transmit a first message by radio through the radio mesh network for receipt by the destination radio device, wherein the first message encodes an identifier of the source radio device;
each of the one or more intermediate radio devices of the plurality of radio devices, is configured to receive the first message, encode an identifier of the respective intermediate radio device within the first message, and transmit the first message by radio through the radio mesh network along the communication path in a direction towards the destination radio device;
the destination radio device is configured to receive the first message and decode the respective identifiers of the source radio device and of each of the one or more intermediate radio devices from the first message;
the destination radio device is configured to transmit a second message by radio through the radio mesh network for receipt by the source radio device, wherein the second message encodes the respective identifiers of the source radio device and of each of the one or more intermediate radio devices; and
each of the one or more intermediate radio devices is configured to receive the second message, decode from the second message a respective identifier of a respective next radio device along the communication path in a direction towards the source radio device, the respective next radio device being one of the one or more intermediate radio devices or the source radio device, and use the respective identifier to transmit the second message by radio to the respective next radio device.

2. The radio communication system of claim 1, wherein the plurality of radio devices are configured to route the first message according to a tree-based routing protocol.

3. The radio communication system of claim 1, wherein the plurality of radio devices are configured to transmit the first message only to the one or more intermediate radio devices along the communication path and to the destination radio device.

4. The radio communication system of claim 3, wherein the plurality of radio devices are configured to route the first message according to a tree-based routing protocol in which the destination radio device is at a root of the tree.

5. The radio communication system of claim 3, wherein the destination radio device is a gateway to a further network.

6. The radio communication system of claim 1, wherein the plurality of radio devices are configured to route the first message by flooding.

7. The radio communication system of claim 6, wherein the destination radio device is configured, upon receiving a plurality of copies of the first message, to identify a copy that traversed a smallest number of intermediate radio devices between the source radio device and the destination radio device, or to identify a copy that was received first by the destination radio device, and to encode, in the second message, identifiers of the one or more intermediate radio devices decoded from the identified copy.

8. The radio communication system of claim 1, wherein the destination radio device and the one or more intermediate radio devices each configured to transmit the second message to only one respective radio device.

9. The radio communication system of claim 1, wherein the destination radio device is configured to store data associating the source radio device identifier with the identifiers of the one or more intermediate radio devices in a memory of the destination radio device, and to use the stored data when generating or transmitting the second message.

10. The radio communication system of claim 9, wherein the destination radio device is configured to store the data as an entry in a database, and is configured to store respective identifiers of a plurality of different source radio devices in the database in association with respective sets of identifiers of one or more respective intermediate radio devices for the respective source radio devices.

11. The radio communication system of claim 1, wherein all of the plurality of radio devices, or all but one of the plurality of radio devices, are configured to act as intermediate radio devices when receiving a message for which the respective radio device is not the destination of the message.

12. The radio communication system of claim 1, wherein the one or more intermediate radio devices are a plurality of intermediate radio devices and are configured to encode their respective identifiers as an ordered list within the first message, the ordered list corresponding to an order in which the intermediate radio devices are located along the communication path, and wherein the destination radio device is configured to encode the respective identifiers of the one or more intermediate radio devices as a corresponding ordered list within the second message.

13. The radio communication system of claim 1, wherein the destination radio device is configured to transmit the second message in response to receiving the first message.

14. The radio communication system of claim 1, wherein the plurality of radio devices are configured to transmit and receive messages according to a version of the DECT-2020 New Radio standard.

15-18. (canceled)

19. A radio device, for use in a communication system that comprises a plurality of radio devices configured as a radio mesh network, wherein the radio device comprises radio transceiver circuitry for transmitting and receiving messages and is configured to act as an intermediate radio device by:
receiving a first message, for receipt by a destination radio device of the plurality of radio devices, travelling along a communication path through the radio mesh network from a source radio device of the plurality of radio devices to the destination radio device;
encoding an identifier of the device radio within the first message;
transmitting the first message by radio through the radio mesh network along the communication path in a direction towards the destination radio device;
receiving a second message, transmitted by the destination radio device for receipt by the source radio device, wherein the second message encodes the respective identifiers of the source radio device and of each of one or more intermediate radio devices of the plurality of radio devices;
decoding from the second message an identifier of a next radio device along the communication path in a direction towards the source radio device, the next radio device being one of the one or more intermediate radio devices or the source radio device; and
using the identifier to transmit the second message by radio to the next radio device.

20. The radio device of claim 19, configured to transmit the second message only to the next radio device.

21. A method of routing data in a radio mesh network comprising a plurality of radio devices, the method comprising:
a source radio device of the plurality of radio devices transmitting a first message by radio through the radio mesh network for receipt by a destination radio device of the plurality of radio devices, wherein the first message encodes an identifier of the source radio device;
each of one or more intermediate radio devices of the plurality of radio devices, located sequentially along a communication path through the radio mesh network from the source radio device to the destination radio device, receiving the first message, encoding an identifier of the respective intermediate radio device within the first message, and transmitting the first message by radio through the radio mesh network along the communication path in a direction towards the destination radio device;
the destination radio device receiving the first message and decoding the respective identifiers of the source radio device and of each of the one or more intermediate radio devices from the first message;
the destination radio device transmitting a second message by radio through the radio mesh network for receipt by the source radio device, wherein the second message encodes the respective identifiers of the source radio device and of each of the one or more intermediate radio devices; and
each of the one or more intermediate radio devices receiving the second message, decoding from the second message a respective identifier of a respective next radio device along the communication path in a direction towards the source radio device, the respective next radio device being one of the one or more intermediate radio devices or the source radio device, and using the respective identifier to transmit the second message by radio to the respective next radio device.

22. The radio device of claim 19, configured for routing the first message according to a tree-based routing protocol.

23. The radio device of claim 19, configured for routing the first message by flooding.

24. The method of claim 21, comprising routing the first message according to a tree-based routing protocol or by flooding.
